(19) United States
(12) Patent Application Publication
(10) Pub. No.: US 2004/0082420 A1
(43) Pub. Date: Apr. 29, 2004

(54) Planetary drive hub

(76) Inventor: Geoffrey P. Robinson, West Yorkshire Carleton (GB)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 10/471,182

(22) PCT Filed: Feb. 27, 2002
(86) PCT No.: PCT/GB02/00860

(51) Int. Cl. F16H 13/06

(52) U.S. Cl. 475/183

(57) ABSTRACT

There is provided a planetary drive hub (10) for connection to a drive shaft (11). The hub (10) has a wheel bearing carrier (13) which supports an annular toothed ring (14). A wheel flange (29) is mounted on a hub shaft (18) which is supported within the bearing carrier (13) by means of a primary hub bearing (19). The hub shaft also provides a planetary hub bearing (19). The hub shaft also provides a planetary arms (36) for receiving equiangularly spaced planetary gear arrangements (37) for engagement with the ring (14). Each planetary gear arrangement (37) is mounted on a planetary pin (41) which extends through a hole (38) provided in the planetary arm (36). The planetary pin (41) has a formed end (44) which is formed around the axially inner end of the inner race (45) of the planetary gear arrangement (37).

The present invention relates to planetary drive hubs and more particularly, but not exclusively, to planetary drive hubs for heavy industrial, agricultural or military vehicles.

According to the present invention there is provided a planetary drive hub comprising: a hub, a housing, at least one bearing interposed between the hub and the housing to enable relative rotation between the hub and the housing, an axle shaft, a drive assembly comprising a sun member coaxially mounted on the shaft, an annular ring member surrounding the sun member and a planet member carrier positioned coaxially with the sun member and carrying a plurality of spaced, rotatable planet members disposed between the sun member and the annular ring member, the planet members being mounted on pins fixedly attached to the planet member carrier, wherein the planet member carrier has a plurality of through holes with each of the through holes having first formation means on the side opposite the planet members, each of the pins having at one end second formation means and an elongate portion extending from the second formation means, each elongate portion having a formed lip at its end opposite the second formation means which formed lips retain the pins on the planet member carrier and secure the planet members on the respective pins.

Preferably the mounting pins are hollow. In some arrangements each first formation means comprises a counterbore in the through hole and the second formation means of each pin comprises a flange which fits in said counterbore, the formed lip being formed about the end of the planet member remote from the planet member carrier.

In other arrangements each second formation means comprises a flange which engages the end of the planet member remote from the planet member carrier and the formed lip is formed about the first formation means. Ideally with this latter arrangement each first formation means comprises a counterbore in the through hole, the formed lip being disposed in the counterbore.

Usually the hub has a bearing mounting portion around which the inner race means of the bearing is mounted, the bearing having outer race means located within the housing and rolling elements provided between the inner and outer race means. Ideally the hub is solid for substantially the whole axial distance of said bearing mounting portion.

In preferred arrangements the planet members are tapered roller bearings. In some constructions the tapered roller bearings each have an outer race, the outer race having gear teeth provided on its radially outer surface for engaging gear teeth provided on the radially inner surface of said annular ring member and on the radially outer surface of the sun member. In other constructions the tapered roller bearings each have an outer race, the outer race having a friction surface provided on its radially outer surface for engaging corresponding friction surfaces provided on the radially inner surface of said annular ring member and on the radially outer surface of the sun member.

It is a preferred feature that the hub has a flange for mounting a wheel, a shoulder, a spindle projecting from the shoulder and retaining means at the opposite end of the spindle to the shoulder.

With some embodiments the planet member carrier is integral with the hub, the flange has a through bore provided with a recess and the hub spindle has an axial extension, the flange being fixedly attached to the hub by forming the axial extension of the spindle into the recess and in addition the bearing is held between the shoulder on the hub and the wheel mounting flange. Furthermore the shoulder is formed by the integral planetary member carrier and in addition the wheel mounting flange has splines on its through bore, which splines engage with splines provided on the outer peripheral surface of the axial extension of the spindle.

With other embodiments the wheel mounting flange is integral with the hub, the planet member carrier has a through bore provided with a recess and the hub spindle has an axial extension, the planet member carrier being fixedly attached to the hub by forming the axial extension of the spindle into the recess and also the bearing is held between the shoulder on the hub and the planetary member carrier which is fixedly attached to the hub. Furthermore the inner race means projects beyond the mounting seat and in addition the planet member carrier has splines on its through bore, which splines engage with splines provided on the outer peripheral surface of the axial extension of the spindle.

Normally the bearing comprises two inner races and two outer races and the bearing is pre-adjusted to a predetermined bearing setting prior to mounting the planetary drive hub on to a vehicle.

According to the present invention there is also provided a planetary drive hub for a vehicle wheel end comprising a planetary drive and a rolling element bearing wherein the planetary drive and the bearing are pre-assembled for mounting to a wheel end as a unit with the bearing setting established prior to mounting.

Embodiments of the present invention will now be described in more detail. The description makes reference to the accompanying drawings in which:

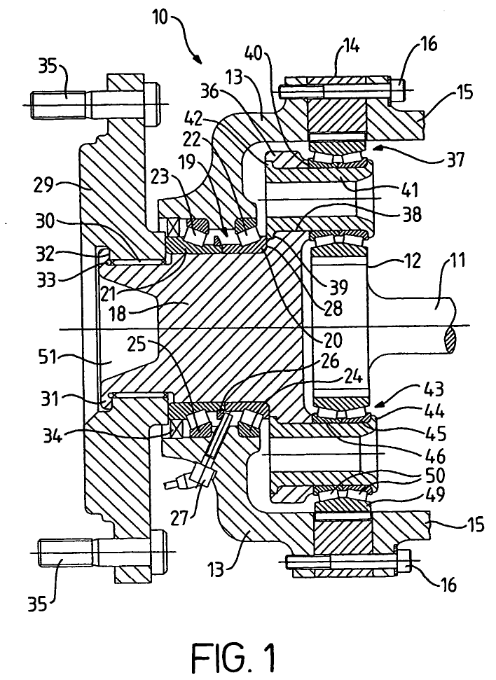

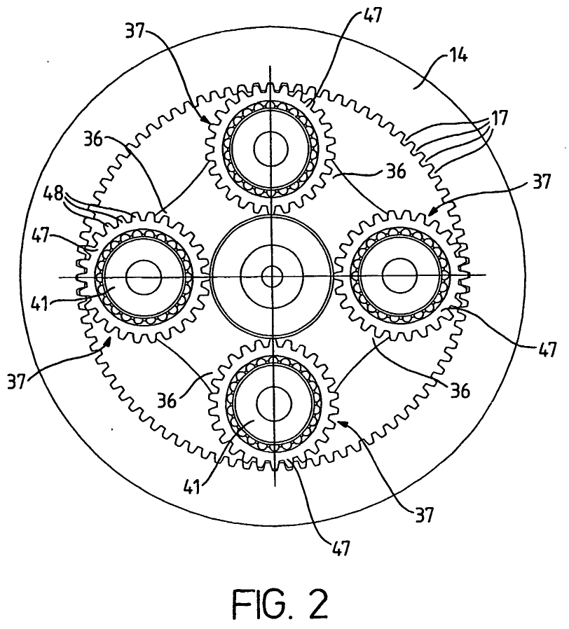

FIG. 1 shows a longitudinal cross-section through a drive hub according to the present invention, FIG. 2 shows a right hand end view of the FIG. 1 drive hub excluding the pivot casting,

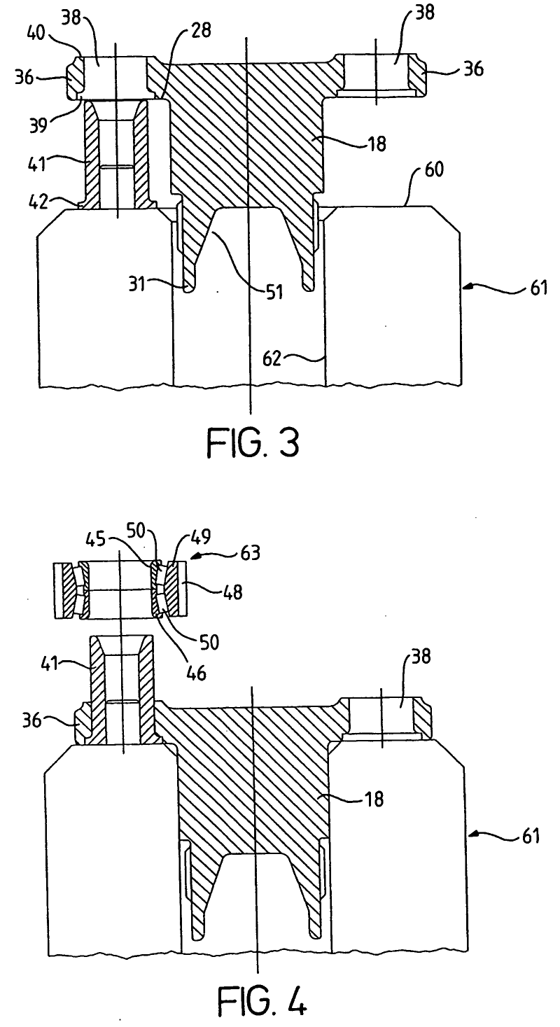

FIGS. 3 to 6 show in cross-section the steps in assembly of the planetary assembly of the hub shown in FIGS. 1 and 2,

FIG. 7 shows an end view of an alternative embodiment of drive hub,

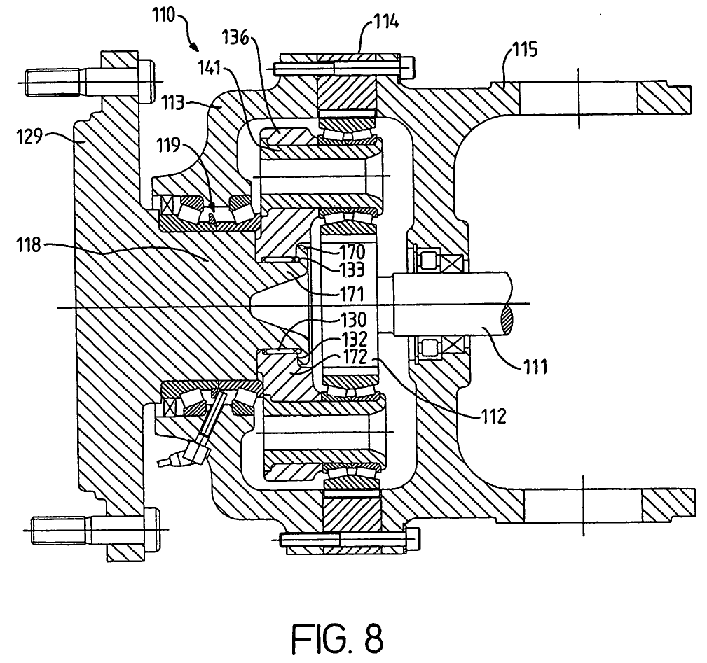

FIG. 8 shows a longitudinal cross-section through a further embodiment of drive hub, and

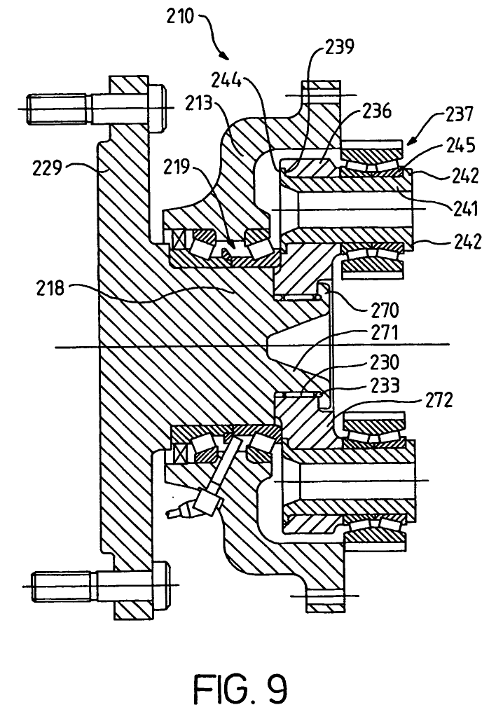

FIG. 9 shows a longitudinal cross-section through part of a still further embodiment of drive hub.

In FIGS. 1 to 6 there is shown a planetary drive hub 10 for connection to a drive shaft 11 having a drive gear 12 at its axial end. The drive hub 10 has a wheel bearing carrier 13 which fixedly supports an annular ring 14 with respect to an axle arm casting 15 by means of bolts 16. The annular ring 14 has teeth 17 provided around its radially inner surface.

A hub shaft 18 is supported within the bearing carrier 13 by means of a primary hub bearing 19. In this embodiment the hub bearing 19 has an inboard inner race 20 and an outboard inner race 21 mounted on the shaft 18, inboard and outboard sets of rollers 22, 23, and inboard and outboard outer cups 24, 25 mounted on the bearing carrier 13. A tone ring 26 is provided on the outboard inner race 21 and an associated sensor 27 is provided in a bore in the bearing carrier 13.

The hub shaft 18 provides an inboard shoulder 28 against which the inboard inner race 20 abuts and the outboard inner race 21 abuts a wheel flange 29. The wheel flange 29 is mounted on the outboard axial end of the hub shaft by means of splines 30 and the remotest outboard end 31 of the hub shaft 18 is formed around a shoulder 32 provided by the wheel flange 29 and a circlip 33. The formed end 31 sets the hub bearing 19 and, with the splines 30, secures the wheel flange 29 relative to the hub shaft 18.

A conventional dynamic seal 34 is used to seal the outboard end of the hub bearing 19. Wheel securing bolts 35 are provided on the wheel flange 29 in a standard manner.

The hub shaft 18 at its inboard end provides planetary arms 36 for receiving the four planetary gear arrangements 37 at equiangular spacing around the central axis. Each planetary arm 36 has an axial through hole 38 and provides a recessed shoulder 39 at the outboard axial end of the hole 38 and an inboard abutment face 40. Received in each hole 38 is a planetary pin or sleeve 41 having at its outboard end a flange 42 which is received in the recessed shoulder 39. A roller bearing 43 is provided on the inboard end of the sleeve in abutment with the abutment shoulder 40 of the planetary arm 36. The remote inboard end 44 of the sleeve 41 is formed around the inboard inner race 45 of the roller bearing 43 to set the bearing 43 and to secure the inboard inner race 45 and the outboard inner race 46 relative to the planetary sleeve 41 and the hub shaft 18.

A planetary gear 47 having external teeth 48 for meshing with the teeth 17 of the annular ring 14 and with the teeth of the drive gear 12 is rotatably mounted on each planetary sleeve 41. The planetary gear 47 provides outer races 49 for rolling elements 50 provided between the inner races 45, 46 and the outer races 49. Each planetary gear arrangement 37 is, therefore, essentially a tapered roller bearing with teeth 48 on the outer surface of the outer race 49.

It will be appreciated that rotation of the drive shaft 11 causes the planetary gears 47 to rotate about the respective planetary sleeves 41. The engagement of the planetary gears 47 with the annular ring 14 causes the hub shaft and attached wheel flange 29 to rotate also. The ratio of drive shaft 11 rotation to wheel flange 29 rotation is a matter of design choice in the standard manner but an example may be 4:1 for applications in industrial vehicles such as earth movers.

FIGS. 3 to 6 show four steps in a method of assembling the planetary gear arrangements 37 relative to the planetary arms. FIG. 3 shows the hub shaft 18, prior to attachment of the wheel flange 29, being lowered over one of the four planetary sleeves 41 which is standing on a upper surface 60 of a press tool station 61. The splined end of the hub shaft 18 is received in a central bore 62 in the press tool station 61.

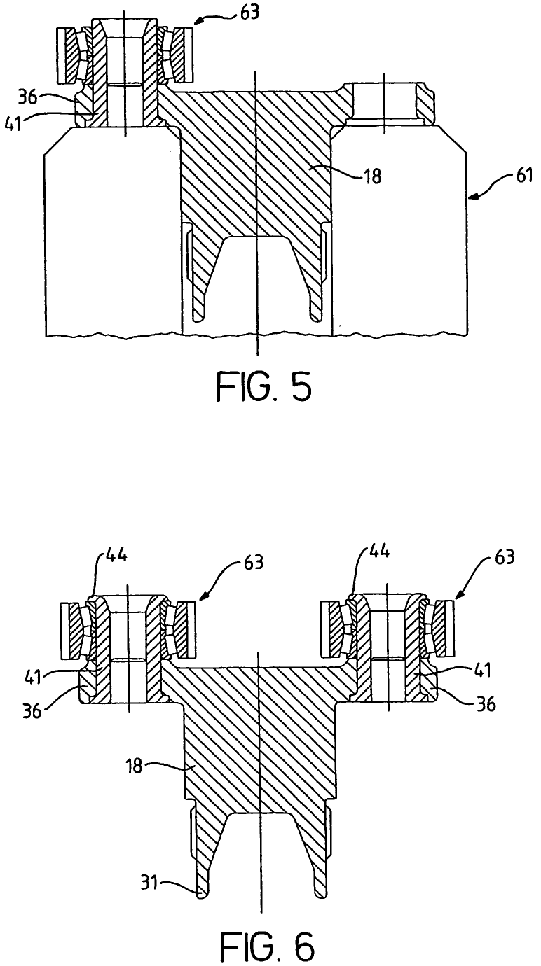

FIG. 4 shows the hub shaft 18 fully lowered such that the end flange 42 of the planetary sleeve 41 is received in the recessed shoulder 39. The planetary gear pack 63 comprising the planetary gear 47, rolling elements 50 and inner races 45, 46 is then pressed over the exposed inboard end of the planetary sleeve 41 until the outboard inner race 46 abuts the abutment shoulder 40 of the planetary arm 36. This is shown in FIG. 5. The exposed inboard end 44 of the planetary pin 41 is then formed radially outwardly about the inboard end of the inboard inner race, the planetary gear 47 being able to rotate relative to the planetary sleeve 41 and the hub shaft 18.

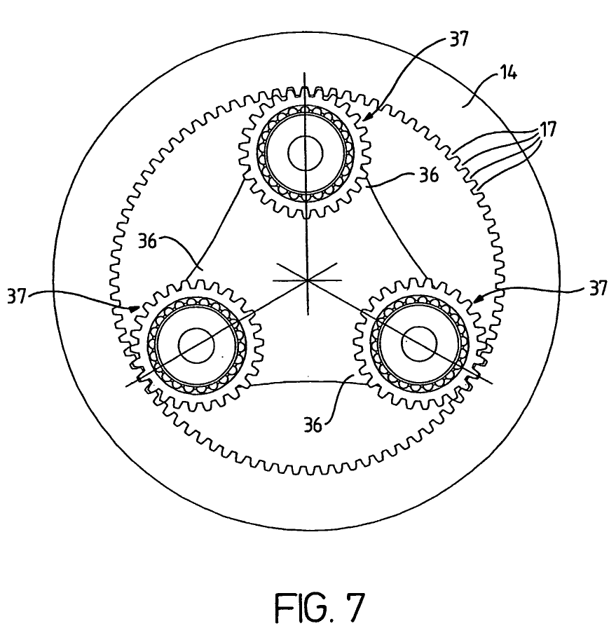

FIG. 6 shows the fully assembled hub shaft 18/planetary gear arrangement prior to attachment to the wheel flange 29. A similar type of process is used for this latter attachment, the hub bearing 19 and bearing carrier 13 being assembled on to the hub shaft 18 prior to the wheel flange 29 being attached to the splined end. The exposed outboard end 31, defined by an axial recess 51 so as to be sleeve like, is then formed radially outwardly around the circlip 33 and into the shoulder 32 of the wheel flange 29.

It will be appreciated that the formed ends serve a dual purpose, namely setting and locating the bearings and also securing two component parts relative to each other.

In FIG. 7 there is shown an end view of alternative arrangement in which the hub shaft provides three planetary arms 36 instead of four. It would of course be possible for the hub shaft to provide any other number of planetary arms carrying planetary gear arrangements.

In FIG. 8 there is shown a further alternative arrangement 110 which is similar in many ways to that shown in FIGS. 1 and 2. Like parts have, therefore, been given the same reference numerals except with an additional prefix ‘1’. The main area of difference with the FIG. 8 construction is in the area of the hub shaft 118 and in addition the annular ring 114 is, in this example, attached to a pivot casting 115 rather than an axle arm. In FIG. 8 the hub shaft 118 is formed as an extension of the wheel flange 129. The inboard end 170 of the hub shaft 118 is formed as a sleeve 171. The planetary arms 136 are formed as part of a hub member 172 through which the sleeve 171 extends in splined engagement. The inboard end 170 of the sleeve 171 is then formed about a circlip 133 and around a shoulder 132 formed in the hub member 172. The formed end sets the hub bearing 119 and, with the splines 130, secures the wheel flange 129 relative to the planetary hub member 172.

In FIG. 9 there is shown a still further embodiment which is similar in many ways to that shown in FIG. 8 and also to that shown in FIGS. 1 and 2. Like parts have, therefore, been given the same reference numerals except with a prefix ‘2’. The pivot casting, drive shaft, drive gear and annular ring have not, however, been shown in FIG. 9 for simplicity. The main difference between the FIG. 9 arrangement and the earlier FIG. 8 arrangement is in the retention of pins 241 on the planetary arms 236. In the FIG. 9 arrangement the disposition of the pins 241 has been reversed such that for each pin 241, the flange 242 engages the end of the inner races 245 of the planetary gear arrangements 237 which is remote from the planetary arm 236. The end 244 of each pin 241 remote from the flange 242 is then formed into the recessed shoulder 239 of the planetary arm 236 thereby securing the inner race 245 of the planetary gear arrangement 237 with respect to the planetary arm 236. A similar modification could be made to the FIG. 1 construction.

Although the arrangements described above have a planetary gear drive, it is also possible for the gear drive to be replaced by a planetary traction or friction drive. In other alternative arrangements the planetary drive could be disposed outboard of the wheel rather than inboard as described above. It will also be appreciated that although the above arrangements show tapered roller bearings, they could be modified to use other types of bearing.

1. A planetary drive hub comprising: a hub, a housing, at least one bearing interposed between the hub and the housing to enable relative rotation between the hub and the housing, an axle shaft, a drive assembly comprising a sun member coaxially mounted on the shaft, an annular ring member surrounding the sun member and a planet member carrier positioned coaxially with the sun member and carrying a plurality of spaced, rotatable planet members disposed between the sun member and the annular ring member, the planet members being mounted on pins fixedly attached to the planet member carrier, wherein the planet member carrier has a plurality of through holes with each of the through holes having first formation means on the side opposite the planet members, each of the pins having at one end second formation means and an elongate portion extending from the second formation means, each elongate portion having a formed lip at its end opposite the second formation means which formed lips retain the pins on the planet member carrier and secure the planet members on the respective pins.

2. A hub as claimed in claim 1 wherein the mounting pins are hollow.

3. A hub as claimed in claim 1 or claim 2 wherein each first formation means comprises a counterbore in the through hole and the second formation means of each pin comprises a flange which fits in said counterbore, the formed lip being formed about the end of the planet member remote from the planet member carrier.

4. A hub as claimed in claim 1 or claim 2 wherein each second formation means comprises a flange which engages the end of the planet member remote from the planet member carrier and the formed lip is formed about the first formation means.

5. A hub as claimed in claim 4 wherein each first formation means comprises a counterbore in the through hole, the formed lip being disposed in the counterbore.

6. A hub as claimed in any one of claims 1 to 5 wherein the hub has a bearing mounting portion around which the inner race means of the bearing is mounted, the bearing having outer race means located within the housing and rolling elements provided between the inner and outer race means.

7. A hub as claimed in claim 6 wherein the hub is solid for substantially the whole axial distance of said bearing mounting portion.

8. A hub as claimed in any one of claims 1 to 7 wherein the planet members are tapered roller bearings.

9. A hub as claimed in claim 8 wherein the tapered roller bearings each have an outer race, the outer race having gear teeth provided on its radially outer surface for engaging gear teeth provided on the radially inner surface of said annular ring member and on the radially outer surface of the sun member.

10. A hub as claimed in claim 8 wherein the tapered roller bearings each have an outer race, the outer race having a friction surface provided on its radially outer surface for engaging corresponding friction surfaces provided on the radially inner surface of said annular ring member and on the radially outer surface of the sun member.

11. A hub as claimed in any one of claims 1 to 10 wherein the hub has a flange for mounting a wheel, a shoulder, a spindle projecting from the shoulder and retaining means at the opposite end of the spindle to the shoulder.

12. A hub as claimed in claim 10 wherein the planet member carrier is integral with the hub, the flange has a through bore provided with a recess and the hub spindle has an axial extension, the flange being fixedly attached to the hub by forming the axial extension of the spindle into the recess.

13. A hub as claimed in claim 11 or claim 12 wherein the bearing is held between the shoulder on the hub and the wheel mounting flange.

14. A hub as claimed in any one of claims 10 to 13 wherein the shoulder is formed by the integral planetary member carrier.

15. A hub as claimed in claim 12 or claims 13 or 14 when dependent on claim 12 wherein the wheel mounting flange has splines on its through bore, which splines engage with splines provided on the outer peripheral surface of the axial extension of the spindle.

16. A hub as claimed in claim 11 wherein the wheel mounting flange is integral with the hub, the planet member carrier has a through bore provided with a recess and the hub spindle has an axial extension, the planet member carrier being fixedly attached to the hub by forming the axial extension of the spindle into the recess.

17. A hub as claimed in claim 11 or claim 16 wherein the bearing is held between the shoulder on the hub and the planetary member carrier which is fixedly attached to the hub.

18. A hub as claimed in claim 17 when dependent on claim 6 wherein the inner race means projects beyond the mounting seat.

19. A hub as claimed in any one of claims 16 to 18 wherein the planet member carrier has splines on its through bore, which splines engage with splines provided on the outer peripheral surface of the axial extension of the spindle.

20. A hub as claimed in any one of claims 1 to 19 wherein the bearing comprises two inner races and two outer races and the bearing is pre-adjusted to a predetermined bearing setting prior to mounting the planetary drive hub on to a vehicle.

21. A planetary drive hub for a vehicle wheel end comprising a planetary drive and a rolling element bearing wherein the planetary drive and the bearing are pre-assembled for mounting to a wheel end as a unit with the bearing setting established prior to mounting.

22. A planetary drive hub as claimed in claim 21 incorporating any of the features claimed in claims 1 to 20.
